(19) United States
(12) Patent Application Publication
(10) Pub. No.: US 2010/0082819 A1
(43) Pub. Date: Apr. 1, 2010

(54) NETWORK BRIDGING APPARATUS FOR STORAGE DEVICE AND DATA STREAM TRANSMITTING METHOD THEREOF

(75) Inventor: Cheng-Chieh Wang, Sanchong City (TW)

Correspondence Address: NIKOLAI & MERSEREAU, P.A., 900 SECOND AVENUE SOUTH, SUITE 820, MINNEAPOLIS, MN, 55402, US

(73) Assignee: JW ELECTRONICS CO., LTD., Taipei City (TW)

(21) Appl. No.: 12/539,785

(22) Filed: Aug. 12, 2009

(30) Foreign Application Priority Data
Oct. 1, 2008 (TW) 97137703

(51) Int. Cl. G06F 13/36; G06F 15/16

(52) U.S. Cl. 709/227; 710/306; 709/246

(57) ABSTRACT

A network bridging apparatus for a storage device and a data stream transmitting method thereof are provided. More particularly, a chip embedded with ATA over Ethernet (AoE) technology is incorporated into the network bridging apparatus. By which the independent-external storage device can be shared over a network. According to a preferred embodiment, a bridging module having the technology of AoE is included for converting either network packets or data being compatible with some standard data transmission formats. Preferably, one end of the apparatus is equipped with a network interface unit for connecting to the network, and further, the other end of the network bridging apparatus is connected to a storage device via a transmission interface. Therefore, the storage device using a standard transmission interface, such as USB, IEEE1394. eSATA or the like, can be shared with other computer systems within the local area network.

### BACKGROUND OF THE INVENTION

1. Field of the Invention

The present invention generally relates to a network bridging apparatus for storage device and a data stream transmitting method thereof, more particularly incorporating a disk storage technology over Ethernet in an external storage device that can be shared over a network.

2. Description of Related Art

In a usual computer system the capacity of memory essentially dominates the performance of data processing of the computer system. Thus the user may utilize an external storage device for backing up data of the computer system since the internal storage is limited. For an example shown in FIG. 1, that illustrates a schematic diagram of a connection between a desktop computer 10 and an external hard disk 12. The connector 101 interconnected with the external hard disk t2 and the computer 10 can be USB, firewire, or other modem connectors. The external hard disk 12 provides an extra capacity for the computer system, and generally the external hard disk 12 is a portable device. It's easy to share with others using this kind of portable devices.

The external storage usually connects to a computer host via USB, and becomes one of the storages. Reference is made to U. S. Patent Pub. No. 2006/0190669 that describes a wireless hard drive. The hard drive has embedded wireless transmission chip and antenna. The data stored in the wireless hard drive is shared with the computer hosts within a wireless LAN via a specific wireless communication protocol.

So that the computer system may access a remote storage device over a netfork in addition to the computer system has locally connected with some external storage devices, such as a hard disk, a disk drive, or an optical disk. Conventionally a virtual volume technology is used for performing a remote redundancy. The used technologies such as NAS (Network-Attached Storage), SAN (Storage Area Network), iSCSI (Internet SCSI), AoE (ATA over Ethernet), and in combination thereof may be used in the conventional art.

The abovementioned remote storage technologies are incorporated in connecting to both a storage system in local area network (LAN) over a network and a remote storage system in WAN such as Internet. The storage system usually includes hard disks with a transmission standard, preferably IDE, SCSI or their combination. A RAID technology is often used. Therefore a user may access the storage system via a standard communication interface, or over a network. Those standards are preferably the iSCSI, SMB (Service Message Block), NFS (Network File System), CIF (Common Internet File System), IPX (Inter-network Packet Exchange), and SPX (Sequenced Packet Exchange).

### SUMMARY OF THE INVENTION

It is different from the conventional remote storage technologies over a wireless or wired network, a network bridging apparatus for a storage device and a data stream transmitting method thereof are provided. Particularly a chip incorporated with an ATA-over-Ethernet (AoE) technology over Ethernet is installed in the network bridging apparatus. The claimed network bridging apparatus is provided to share a local storage device with legacy data transmission interface, such as USB, IEEE1394, eSATA or the like, with the computer systems within a local area network.

The network bridging apparatus of the present invention is particularly to incorporate the ATA-over-Ethernet (AoE) technology in converting the network packets broadcasted over Ethernet into the data being compatible with a standard format, and vice versa. The preferred embodiment of the network bridging apparatus for the storage device is equipped with a network interface unit used for connecting with network. A bridging module of ATA-over-Ethernet is further included, in which the module is built over the network for converting either the network packets or the data being compatible with a data transmission format. Further, one end of the network bridging apparatus incorporates a transmission interface in connecting to the bridging module, and further, the other end thereof is connected to an independent-external storage device. The transmission interface can be USB, IEEE1394 or eSATA.

A data stream transmitting method of the claimed network bridging apparatus is further provided. The preferred embodiment thereof has a first step of establishing a connection to a remote device over the network, and connecting to an independent-external storage device. Next, the apparatus performs the further steps of receiving an access command from the remote device, and converting the data format as accessing the independent-external storage device. Particularly, the network packets broadcasted over the network is converted to conform a specific data transmission format if the apparatus operates under a receive mode. Or alternatively, if the apparatus operates under a transmission mode, the data is converted to the network packets broadcasted over the network. Next, the data is broadcasted through the claimed networks bridging apparatus.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of the connection between a computer and an external storage device;

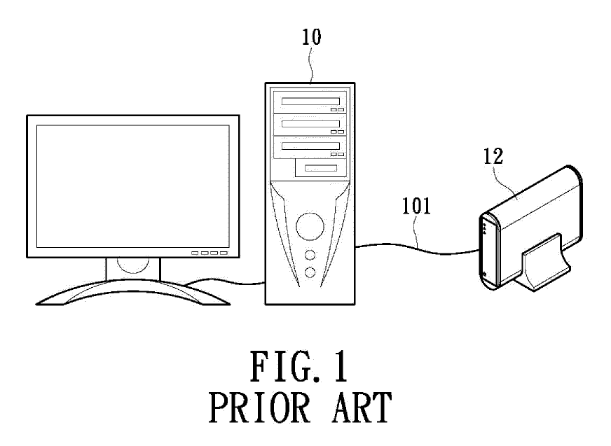

FIG. 2 shows a schematic diagram of the connection preferably used by the network bridging apparatus applied to a storage device of the present invention;

FIG. 3 shows a schematic diagram of the claimed network bridging apparatus of the present invention;

FIG. 4 shows a block diagram of the network bridging apparatus according to the preferred embodiment of the present invention;

FIG. 5 shows a flow chart of the data stream transmission method adapted to the network bridging apparatus according to the embodiment of the present invention.

### DETAILED DESCRIPTION OF THE PREFERRED EMBODIMENTS

Provided of the present invention is a method of sharing the local data storage device over a network. According to a preferred embodiment, an independent-external storage device located at one end of a realm can be shared over the network via a wired connection preferably using a RJ-45 modular jack or wireless connection. Further a connection being compatible with a standard data transmission protocol, preferably as USB (Universal Serial Bus), IEEE1394 (firewire). eSATA (external SATA) or the like, equips the mentioned storage device. The network bridging apparatus of the present invention has particularly incorporated with a processing chip of ATA-over-Ethernet (AoE). The chip is essentially used to convert either the network packets broadcasted over the Ethernet, or the data being compatible with a specific standard transmission format.

In view of the conventional wired or wireless technologies used for providing a remote storage service, provided in the present invention are the network bridging apparatus for a storage device and the data stream transmitting method thereof. The network bridging apparatus has particularly introduced a processing chip of AoE. The AoE technology used in the network bridging apparatus can enhance the local storage device with USB, IEEE1394, eSATA, or the other standard data transmission protocols to share with others. Namely the space of storage device can be shared with the computer systems located within a LAN via this standalone network bridging apparatus.

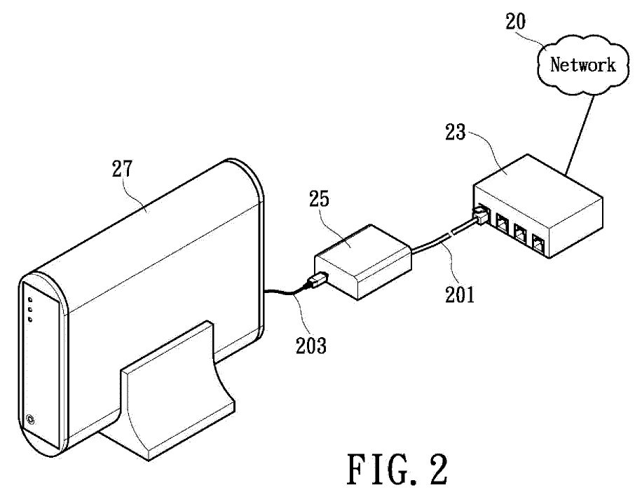

Reference is made to FIG. 2 illustrating a schematic diagram of the connection implemented by the network bridging apparatus according to the preferred embodiment. The diagram shows the embodiment of a network bridging apparatus 25 bridging over a network 20 and an independent-external storage device 27. The network bridging apparatus 25 is especially used for converting the packets broadcasted over the network to the digital data for a common storage device. In particular the network bridging apparatus 25 has a network connection port at one end, which connects to a network device: 23 via a wired network connection 201. This type of network bridging apparatus can be a network switch, a HUB, or a budge, thereby to connect to the network 20. Further, the other end of the network bridging apparatus connects to the independent-external storage device 27 (such as an external hard disk) via a data connection 203. The data connection 203 can be implemented as a connection via USB, IEEE1394, eSATA or other like standard transmission interfaces. The independent-external storage device can also be a USB flash drive using USB port.

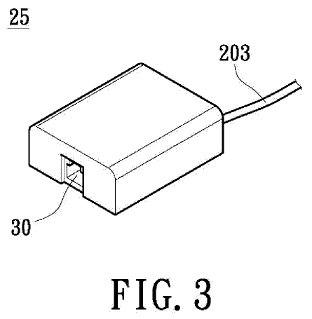

The preferred embodiment of the apparatus shown as the schematic diagram of FIG. 2 is illustrated in FIG. 3. The network bridging apparatus 25 are equipped with two transmission ports preferably connected to outward. One of the transmission ports is a wired network port 30 shown ill a front view of the diagram. RJ-45 modular jack is a general type connected with the network devices. Since the network bridging apparatus 25 is not necessary actively connected with the network, the network bridging apparatus 25 is merely used to convey the data of storage device or the network packets. When the apparatus 25 conveys the AoE-compatible packets, a MAC (Media Access Control) address used in Ethernet is preferably used to determine a source and a target of the packets. Further, the other computer systems within the same network domain can identify the apparatus 25 through the broadcasting packets.

In a preferred embodiment, the network bridging apparatus 25 has an end with the standard data transmission interface, such as USB, IEEE1394, or eSATA. Via the data connection 203, the network bridging apparatus 25 connects to the independent-external storage device, preferably as an external hard disk.

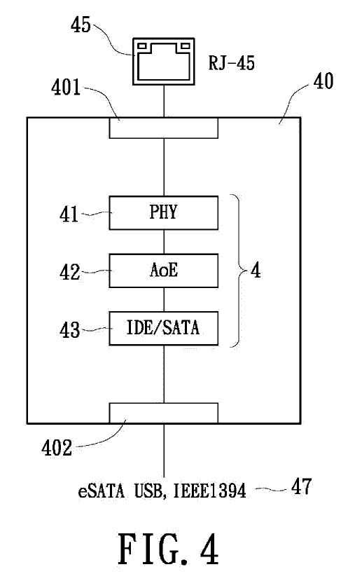

In order to convey the data incorporated with the AoE technology, the network bridging apparatus of the present invention incorporates a processing circuit capable of processing AoE-compatible packets. Reference is made to FIG. 4 showing the block diagram of the network bridging apparatus applied to the storage device.

The network bridging apparatus 40 shown in FIG. 4 has an end connected with the external network device via a network interface unit 40 1. For example, a wired means, such as RJ-45 network port, is used to connect a network switch, a HUB or a bridge. Via broadcasting, the computer systems within the same network domain can identify the claimed network bridging apparatus 40, by which it's to connect to an independent-external storage device 47 (with standard SATA or eSATA). The network bridging apparatus 40 utilizes a transmission interface 402 to connect to the independent-external storage device 47. Referring to the description of the embodiments, one end of the network bridging apparatus 40 electrically connects to a bridging module 4, and the other end connects to the independent-external storage device 47, such as the mentioned storage device.

Since the network bridging apparatus 40 is equipped with the bridging module 4 incorporated with AoE technology, the network interface unit 401 and the transmission interface 402 of the external storage device are interconnected. By which it is used to convert the network packets and the data being compatible with a specific transmission format. Particularly the bridging module 4 can handle multiple threads by the individual circuits or integrated chips. The bridging module 4 at least includes the electrically interconnected network physical unit 41, data conversion unit 42 and interface conversion unit 43 (with standard IDE or SATA).

The network physical unit 41 is used to link the network interface unit 401 ill order to transmit the AoE-compatible packets. The data conversion unit 42 is particularly implemented as a circuit or chip used for processing the packets being compatible with AoE protocol. The data conversion unit 42 is therefore capable of converting either the network packets broadcasted over Ethernet or the data being compatible with a specific format. The data conversion unit 42 operates both a receive mode and a transmit mode.

Under the receive mode, the network packets are converted into the data being compatible with a specific transmission format. Alternatively, the data can be converted into the network packets broadcasted over Ethernet under the transmit mode. The interface conversion unit 43 is used to convert the format of the data trasmission interfaces. Since the formal converted by the data conversion unit 42 can be one of the mentioned formats, the conversion among the data transmission interfaces is preferably performed. After that, the independent-external storage device 47 can be accessed through the transmission interface 402 of the external storage device.

In another embodiment, a wireless network control circuit and an antenna (not shown) may be used in the network interface unit 401, so as to wirelessly connect with the network through the antenna.

In a practical embodiment, the network bridging apparatus 40 can issue the broadcast packets to every device within the network. After that, each device will acknowledge there existing an independent-external storage device connected through the network bridging apparatus 40 within the local network. A user may therefore access a storage space over the network by a computer system. However the computer system may need to install a driver relating to the network bridging apparatus 40 so as to be compliance with the AoE communication protocol. By this AoE communication protocol, the computer system can recognize the storage device over the network. Some operating systems are required to install the driver or the similar program additionally. But some other operating systems, such as Linux or Unix-like OS, already have built-in driver suppoiting the protocol used for recognizing the storage device directly.

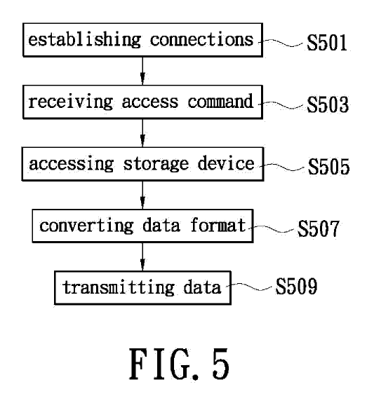

The data stream transmitting method of the present invention is to utilize the above-described network bridging apparatus. Reference is made to FIG. 5 illustrating a flow chart of the claimed method. By way of the network bridging apparatus, the independent-external storage device connects to the network. In the beginning, it is to establish the connections to network, network bridging device and the independent-external storage device. For example, the network bridging apparatus connects to a remote device, such as a computer system, over a network via the network interface unit. In the meantime, broadcast packets are usually used for establishing the first communication. The independent-external storage device is then connected via the transmission interface of the external storage device. (step S501).

Next, the remote device issues an access command to the network bridging apparatus over the network. Where the access command is operated to retrieve data from the independent-external storage device or store data in (step S503). Namely the storage device can be accessed via the network bridging device (step S505). The data being accessed will be converted into another data format by this network bridging apparatus in step S507.

The data conversion unit is specifically used to convert the data being received or transmitted via the network bridging device, including the packets broadcasted over Ethernet and the data being compatible with a specific transmission format. Further, the remote device can directly access the independent-external storage device via the network bridging apparatus over the network, preferably a local area network. After operating the conversion, the data can be swimmingly transmitted therethrough (step S509).

To sum up the above description, provided are the network bridging apparatus for the external storage device and the data stream transmitting method thereof of the present invention. Particularly the claimed apparatus uses a circuit or chip capable of processing the disks incorporated with AoE technology, therefore the local storage device can be shared with the computer systems within the same network.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A network bridging apparatus for a storage device, comprising:
a network interface unit, by which the network bridging apparatus connects to a network;
a bridging module of ATA-over-Ethernet built over the network, electrically connected to the network interface unit for converting network packets or data being compatible with a data transmission format broadcasted over the network; and
a transmission interface of an external storage device, wherein one end of the interface electrically is connected to the bridging module, and the other end thereof is connected to an independent-external storage device; whereby to transmit the converted network packets or the data over the network.

2. The apparatus of claim 1, wherein the network interface unit is a wired port with RJ-45 format used for connecting the network.

3. The apparatus of claim 1, wherein the network interface unit has a wireless-network control circuit, thereby to wirelessly connect to the network.

4. The apparatus of claim 1, wherein the bridging module includes a data conversion unit used for converting the network packets or the data being compatible with the data transmission format broadcasted over the network.

5. The apparatus of claim 4, wherein the bridging module has a network physical-layer unit, electrically connected to the data conversion unit, used for connecting to the network interface unit.

6. The apparatus of claim 4, wherein the bridging module has an interface conversion unit, electrically connected to the data conversion unit, used for connecting to the transmission interface of the external storage device.

7. The apparatus of claim 6, wherein the interface conversion unit is used to convert the format of the data transmission interface.

8. The apparatus of claim 1, wherein the transmission interface of the external storage device is USB.

9. The apparatus of claim 1, wherein the transmission interface of the external storage device is Firewire.

10. The apparatus of claim 1, wherein the transmission interface of the external storage device is eSATA.

11. A data stream transmitting method of the network bridging apparatus of claim 1 for a storage device, in which the network bridging apparatus is used to bridge a network and an independent-external storage device, the method comprising:
establishing a connection to a remote device over the network, and further connecting to the independent-external storage device;
receiving an access command from the remote device:
accessing the independent-external storage device;
converting data format of the data received or transmitted by the network bridging apparatus, network packets broadcasted over the network is converted to conform a data transmission format under a receive mode; data is converted to the network packets broadcasted over the network under a transmission mode; and
transmitting data via the network bridging apparatus.

12. The method of claim 11, wherein the network bridging apparatus issues a broadcast packet, and the remote device identifies the network bridging apparatus by the broadcasted packet, so as to establish the connection.

13. The method of claim 11, wherein the remote device is a computer system to be connected through a network device.

14. The method of claim 11, wherein the step of converting data format has a process of converting data transmission interface format by an interface con version unit.

15. The method of claim 14, wherein the interface conversion unit is to convert data transmitted between an IDE data transmission interface and a USB data transmission interface.

16. The method of claim 14, wherein the interface conversion unit is to convert data transmitted between an IDE data transmission interface and a Firewire data transmission interface.

17. The method of claim 14, wherein the interface conversion unit is to convert data transmitted between an IDE data transmission interface and an eSATA data transmission interface.

18. The method of claim 11, wherein either the network packet or the data transmitted over the network is converted by a data conversion unit.
